(19) United States
(12) Patent Application Publication
(10) Pub. No.: US 2013/0086758 A1
(43) Pub. Date: Apr. 11, 2013

(54) Safe-Mode Toothbrush Controller

(71) Applicant: Biolase, Inc., Irvine, CA (US)

(72) Inventors: Dmitri Boutoussov, Dana Point, CA (US); Marcia Van Valen, JR., Aliso Viejo, CA (US); Matthew F. Duncan, San Clemente, CA (US); William E. Brown, JR., Roswell, GA (US); Alina Sivriver, Dana Point, CA (US)

(73) Assignee: BIOLASE, INC., Irvine, CA (US)

(21) Appl. No.: 13/646,027

(22) Filed: Oct. 5, 2012

Related U.S. Application Data
(60) Provisional application No. 61/545,012, filed on Oct. 7, 2011.

(51) Int. Cl. A61C 17/16

(52) U.S. Cl. 15/22.1

(57) ABSTRACT

Systems and methods are provided for dental cleaning or whitening. An example toothbrush including a body and a head comprises an electromagnetic-radiation generation component, a safety component, and a transmission component. The electromagnetic-radiation generation component is configured to generate electromagnetic radiation upon activation, the electromagnetic-radiation generation component being located in a body of the toothbrush. The safety component is configured to activate the electromagnetic-radiation generation component in response to an activation event. The transmission component is configured to transmit the electromagnetic radiation to the head of the toothbrush for dental cleaning or whitening.

### CROSS-REFERENCE TO RELATED APPLICATION

This application claims priority to and the benefit of U.S. Provisional Application Ser. No. 61/545,012, filed on Oct. 7, 2011, entitled “SAFE-MODE TOOTHBRUSH CONTROLLER,” of which the entire disclosure (including any and all figures) is incorporated herein by reference.

### TECHNICAL FIELD

This document relates generally to dental care and more particularly to a dental cleaning/whitening apparatus.

### BACKGROUND

Mechanical cleaning of teeth has certain limitations. For example, a toothbrush or dental floss often cannot penetrate into skin tissue or into the deep pockets between teeth and gums to remove bacteria and viral contamination. In addition, toothpaste is usually not very effective in terms of destroying bacteria and viruses. Electromagnetic radiation (e.g., laser) can provide a more effective tool for dental cleaning. For example, a toothbrush with a laser source can direct low power laser on teeth, gums, the deep pockets between teeth and gums, or areas below the gum line to remove bacteria and viruses there, without causing significant pain or inflammation. In addition, electromagnetic radiation (e.g., laser) may be applied on teeth for whitening purposes. For example, a whitening agent may be applied to the teeth, and then low power laser may be directed at the teeth to activate the agent so that the enamels of the teeth can be whitened.

### SUMMARY

In accordance with the teachings herein, systems and methods are provided for dental cleaning or whitening. An example toothbrush including a body and a head comprises an electromagnetic-radiation generation component, a safety component, and a transmission component. The electromagnetic-radiation generation component is configured to generate electromagnetic radiation upon activation, the electromagnetic-radiation generation component being located in a body of the toothbrush. The safety component is configured to activate the electromagnetic-radiation generation component in response to an activation event. The transmission component is configured to transmit the electromagnetic radiation to the head of the toothbrush for dental cleaning or whitening.

In one embodiment, a toothbrush including a body and a head comprises an electromagnetic-radiation generation component, a safety component, and a transmission component. The electromagnetic-radiation generation component is configured to generate electromagnetic radiation, the electromagnetic-radiation generation component being located in a body of the toothbrush. The safety component is configured to prevent the electromagnetic radiation from emitting out of the toothbrush until an actuation event occurs. The transmission component is configured to transmit the electromagnetic radiation to a head of the toothbrush for dental cleaning or whitening.

### BRIEF DESCRIPTION OF THE FIGURES

FIG. 1 depicts an example optical toothbrush.

FIG. 2 depicts certain components of the brush head of the optical toothbrush as shown in FIG. 1.

FIG. 3 depicts an example optical toothbrush with a safety-pattern detection mechanism.

FIG. 4 depicts an example optical toothbrush with an attachment detection mechanism.

FIGS. 5A-5C depict an example twist lock mechanism for the optical toothbrush as shown in FIG. 4.

FIGS. 6A and 6B depict an example optical toothbrush with a switching mechanism.

FIG. 7 depicts an example optical toothbrush with an optical feedback mechanism.

FIGS. 8A and 8B depict an example optical toothbrush with a pressure sensing mechanism.

FIGS. 9A and 9B depict an example optical toothbrush with an optical coupling mechanism.

FIGS. 10A-10C depict an example optical toothbrush with another optical coupling mechanism.

FIGS. 11A-11C depict an example optical toothbrush with a flap valve and a safety switch.

### DETAILED DESCRIPTION

In implementing electromagnetic radiation (e.g., laser) in toothbrushes for everyday use, safety measures can be taken to prevent accidental harm to consumers. For example, a child may point a toothbrush with a laser source toward himself or others to cause harm to the eyes. The present disclosure describes multiple approaches for safely using a toothbrush with a radiation source.

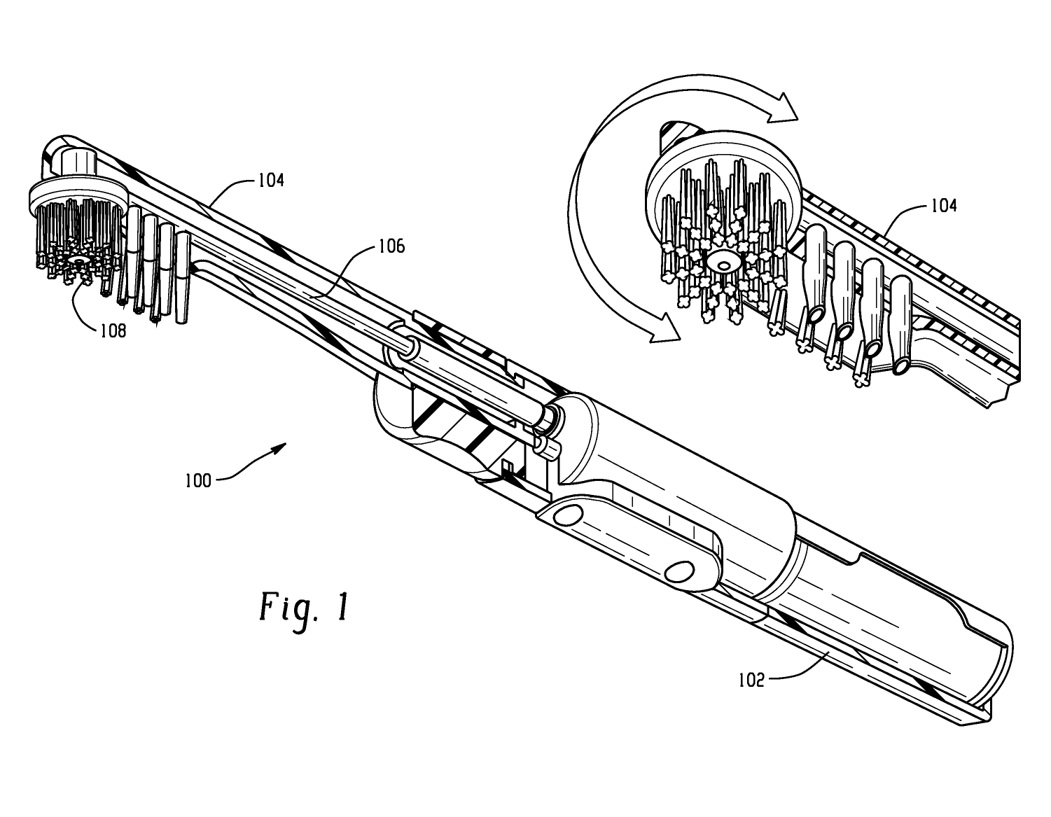

FIG. 1 depicts an example optical toothbrush. The optical toothbrush 100 includes a brush body 102 and a brush head 104. A radiation generation source is contained in the brush body 102 and a light pipe 106 transfers electromagnetic radiation (e.g., laser energy) generated by the radiation generation source to bristles 108 for direct contact transmission or radiation bath. The brush body 102 may include a power supply (e.g., batteries) for the radiation generation source. The brush head 104 may be fixed or movable (e.g., rotatable). The bristles 108 may include optic fibers for guiding electromagnetic radiation (e.g., laser energy). For example, the radiation generation source may include one or more light-emitting diodes, laser diodes, or other suitable radiation generation devices. In another example, the light pipe 106 may be bifurcated to separate blue and red wavelengths.

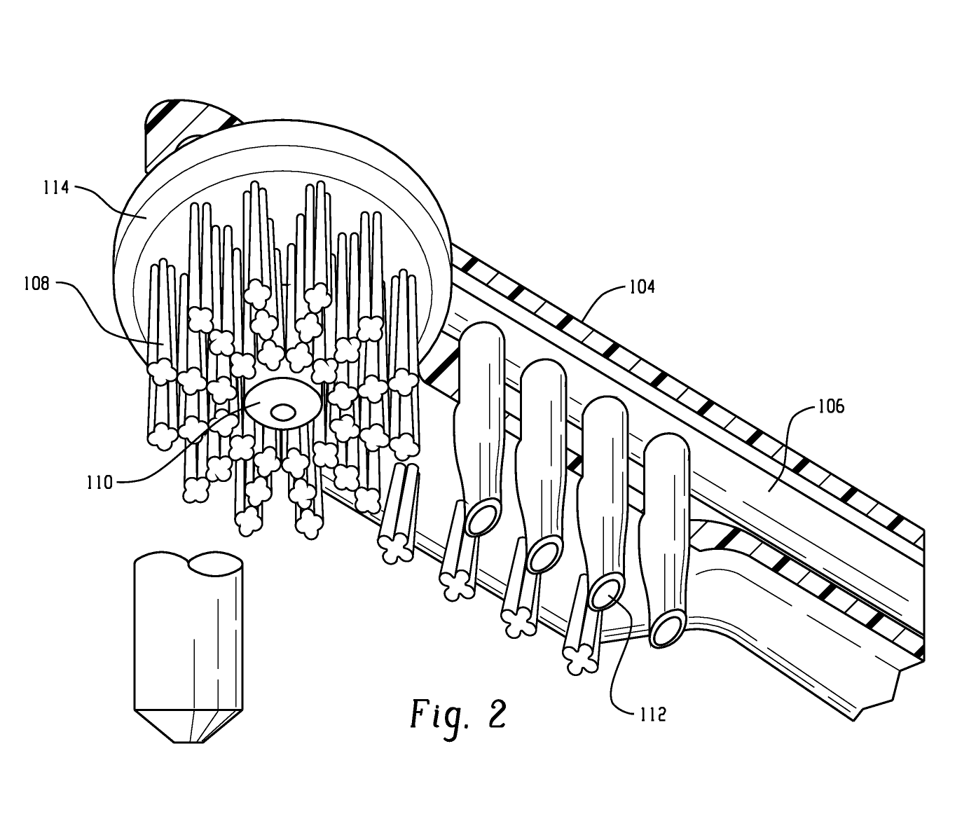

FIG. 2 depicts certain components of the brush head 104 of the optical toothbrush 100 as shown in FIG. 1. The brush head 104 includes a radial brush hub 114 which can rotate around a central pivot point. A truncated cone 110 is located on the radial brush hub 114. For example, the truncated cone 110 can produce safe, diffused lights from electromagnetic radiation (e.g., laser energy) transferred through the light pipe 106. The bristles 108 on the brush head 104 each have an oval end profile 112. For example, the bristles 108 can be made of soft light-conducting silicon that allows the bristle body to flex.

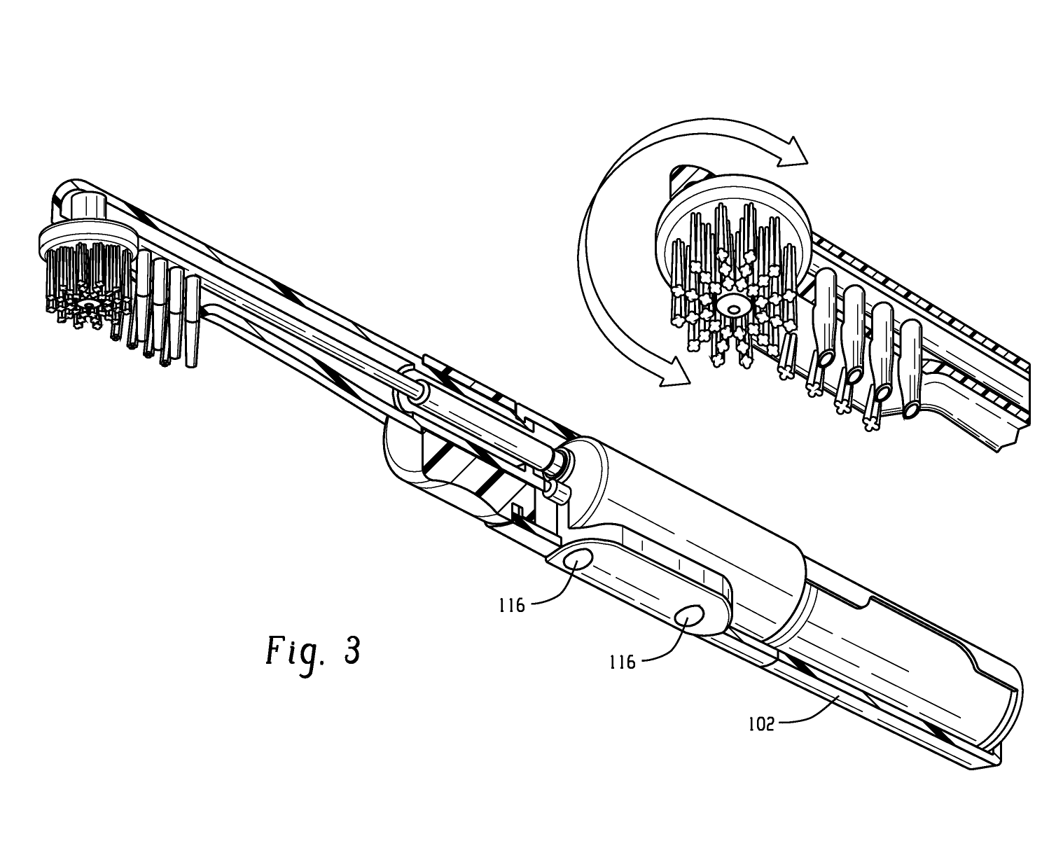

To avoid accidental harm to consumers, the optical toothbrush 100 may include different mechanisms, as shown in FIGS. 3-8B, to prevent the radiation generation source from being activated unless some activation events occur.

FIG. 3 depicts an example optical toothbrush with a safety-pattern detection mechanism. The radiation generation source contained in the brush body 102 is not activated unless a safety pattern is detected. As shown in FIG. 3, one or more buttons 116 may be implemented on the brush body 102. In one embodiment, the radiation generation source contained in the brush body 102 may not be activated unless the buttons 116 are pushed for multiple times (e.g., three times). In another embodiment, the buttons 116 may be pushed for multiple times in a short period of time in order to activate the radiation generation source. In yet another embodiment, multiple buttons 116 need to be pushed simultaneously to activate the radiation generation source. The safety-pattern detection mechanism may be programmable for customization by consumers (or manufacturers).

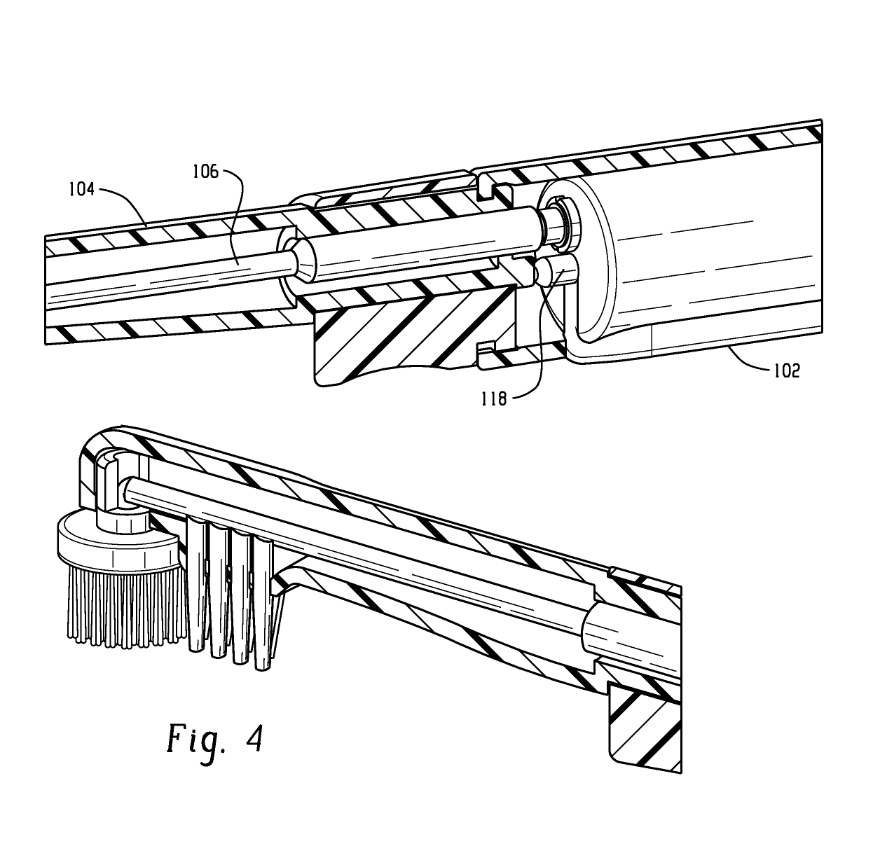

FIG. 4 depicts an example optical toothbrush with an attachment detection mechanism. As shown in FIG. 4, the brush body 102 includes a switch 118 for detecting the attachment of the brush head 104 and the brush body 102 in order to activate the radiation generation source. When the brush head 104 and the brush body 102 are separated, the radiation generation source is not activated and no radiation can come out of the brush body 102. When the brush head 104 is attached to (e.g., inserted into, or twisted on) the brush body 102, a switch 118 that is located in the brush body 102 is engaged and actuated so that the radiation generation source is activated and the radiation (e.g., laser energy) can begin to be transferred through the light pipe 106.

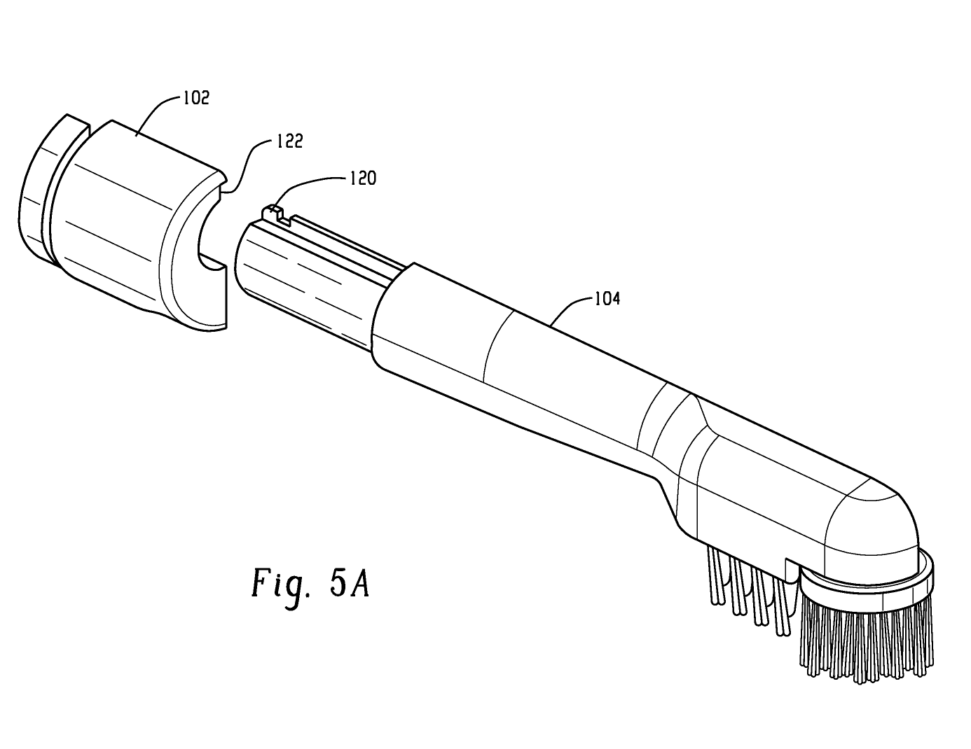

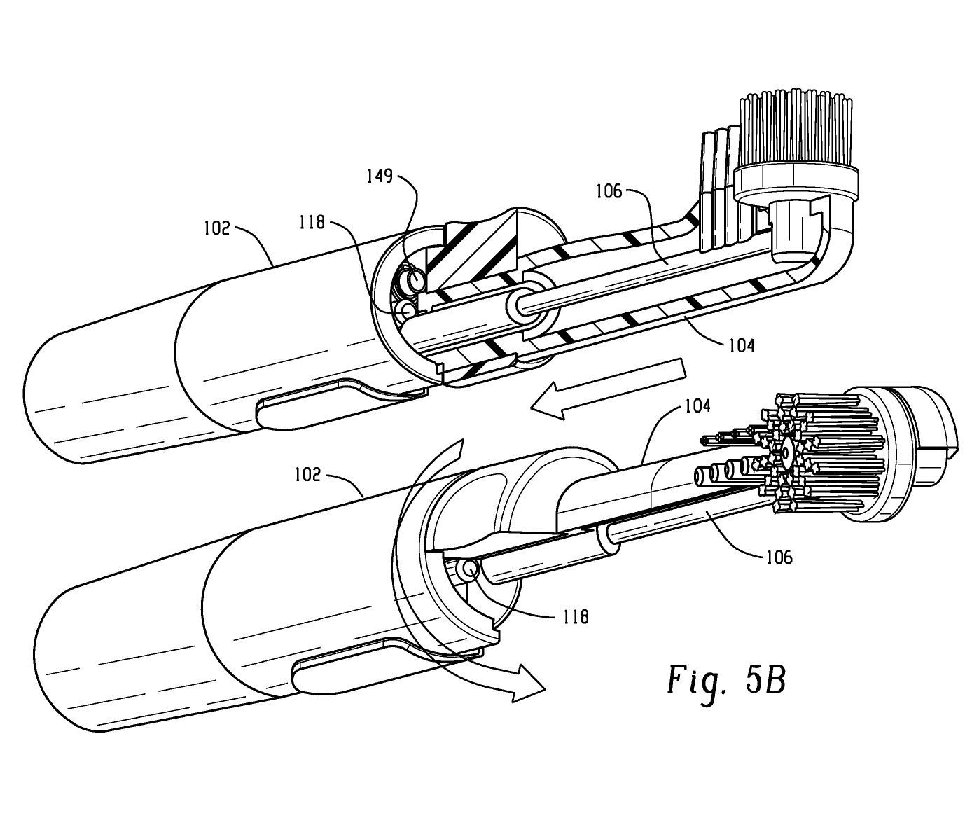

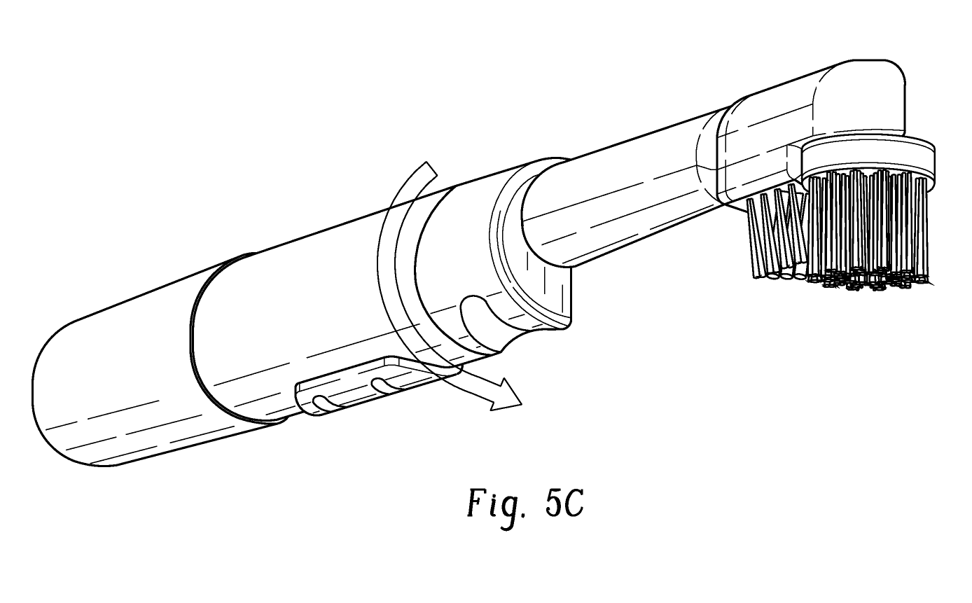

FIGS. 5A-5C depict an example twist lock mechanism for the optical toothbrush as shown in FIG. 4. As shown in FIG. 5A, the brush head 104 includes a key feature 120, and the brush body 102 includes a key slot 122. The brush head 104 can be inserted into the brush body 102 through the key slot 122 (e.g., in an inverted position), as shown in FIG. 5B. Then, the brush head 104 and the brush body 102 are turned in opposite directions respectively (e.g., for 180 degrees) into a locked position, as shown in FIG. 5C. For example, the switch 118 may not be engaged when the brush head 104 is pushed into the brush body 102. Only when the brush head 104 is inserted along the key slot 122 and twisted into the proper position, the brush head 104 may come into contact with the switch 118 which may then be actuated to activate the radiation generation source, as shown in FIG. 5B. In addition, the light pipe 106 may not be aligned with an outlet 149 of the radiation from the radiation generation source until the brush head 104 is twist-locked into the brush body 102. That is, no radiation can be guided to the bristles 108 unless the brush head 104 is properly attached to the brush body 102.

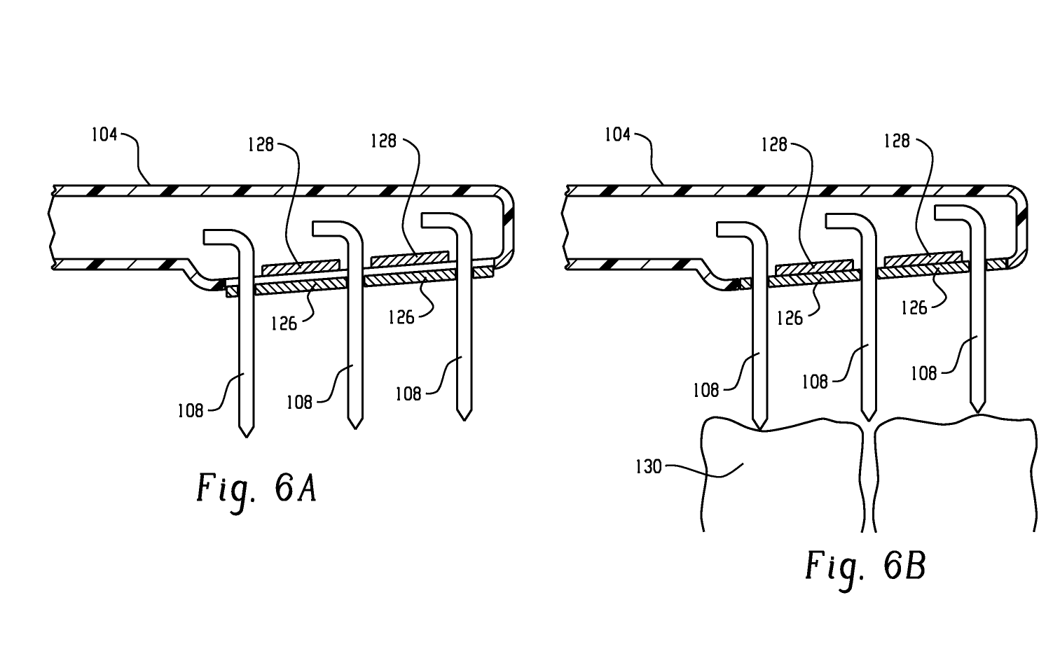

FIGS. 6A and 6B depict an example optical toothbrush with a switching mechanism. As shown in FIGS. 6A and 6B, the brush head 104 includes electrical contacts 126 and 128 which can be used to activate the radiation generation source contained in the brush body 102. The bristles 108 are each bent (e.g., 90 degrees) to receive the electromagnetic radiation (e.g., laser energy) transferred from the light pipe 106 and transmit such radiation downward. The radiation generation source contained in the brush body 102 is not activated when the electrical contacts 126 and 128 are separated as shown in FIG. 6A. When the bristles 108 are in contact with teeth, the resulting pressure on the bristles 108 forces the electrical contacts 126 and 128 into contact as shown in FIG. 6B. Then, the radiation generation source contained in the brush body 102 is activated to generate the radiation (e.g., laser energy) to be transferred to the bristles 108. In one embodiment, the electrical contacts 126 and 128 may be connected directly to the radiation generation source. In another embodiment, a sensor may detect a signal which is generated when the electrical contacts 126 and 128 are forced into contact, and the radiation generation source may then be activated in response to the sensor detecting such a signal. In yet another embodiment, a strain-sensitive pattern may be implemented on the brush head 104. A strain gauge may be used to detect the electrical conductance changes of the strain sensitive pattern in response to the pressure applied on the bristles 108. The radiation generation source may be activated if the changes of the electrical conductance of the strain sensitive pattern exceed a predetermined threshold. For example, the bristles 108 can be periodically placed and staggered to increase the pressure reception area.

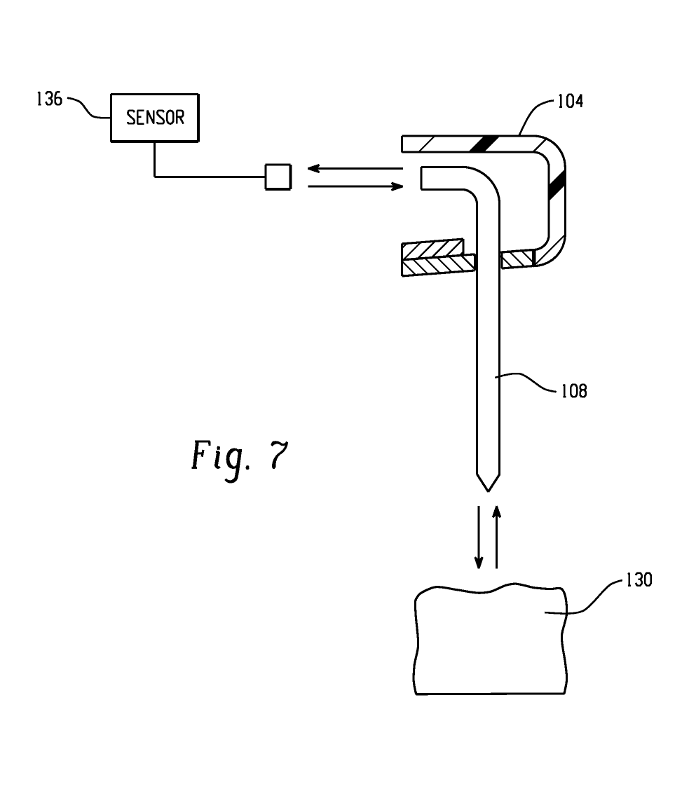

FIG. 7 depicts an example optical toothbrush with an optical feedback mechanism. As shown in FIG. 7, the toothbrush 100 includes a sensor 136 for detecting optical reflection from tooth enamels in order to activate full-power laser transmission. Initially, the radiation generation source contained in the brush body 102 may generate a sensing signal (e.g., 0.1 mW) which is transmitted out of the toothbrush 100. The sensor 136 detects the reflection of the sensing signal. If the detected reflection exceed a threshold power (e.g., 0.01 mW) or a threshold wavelength, then the radiation generation source in the brush body 102 may be activated to generate full-power laser emission (e.g., 10-100 mW). The radiation generation source contained in the brush body 102 may periodically (or continuously) generate sensing signals and the sensor 136 can continue to check the reflection of the sensing signals to prevent accidents. In one embodiment, as shown in FIG. 7, the sensing signal is transmitted out of the bristles 108, and the sensor 136 detects the reflection through the bristles 108. If the bristles 108 are close to non-reflective surfaces (e.g., eyes), the detected reflection may have very low power and the radiation generation source will not be activated. On the other hand, if the bristles 108 are close to the teeth 130, the detected reflection from the tooth enamels may exceed the predetermined threshold, and the radiation generation source may be activated. In another embodiment, the sensing signal is transmitted out of other parts of the brush head 104 instead of the bristles 108, and the sensor 136 detects the reflection through other parts of the brush head 104. The optical feedback mechanism may be combined with other safety mechanisms.

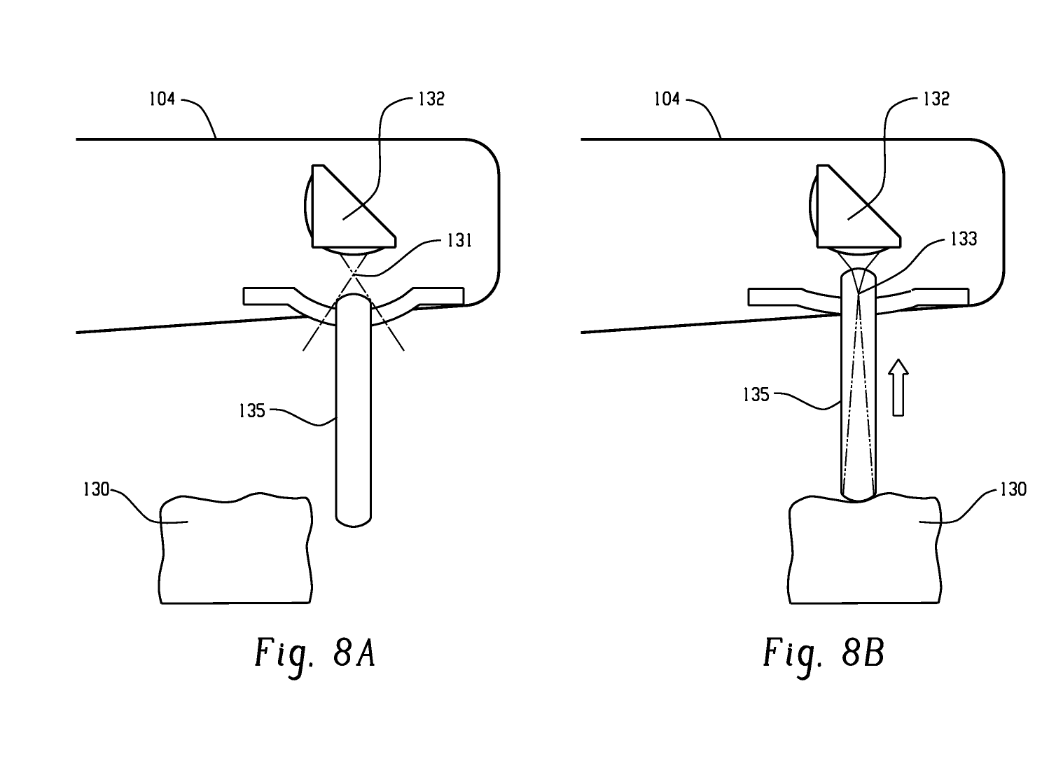

Furthermore, to avoid accidental harm to consumers, the optical toothbrush 100 may include different mechanisms, as shown in FIGS. 8A-10C, to prevent electromagnetic radiation (e.g., laser energy) generated by the radiation generation source from emitting out of the toothbrush 100 unless some actuation events occur.

FIGS. 8A and 8B depict an example optical toothbrush with a pressure sensing mechanism. As shown in FIGS. 8A and 8B, the brush head 104 includes a beam reflector/refactor 132 for each of the bristles which can reflect/refract the electromagnetic radiation (e.g., laser energy) guided toward the bristles. For example, when a bristle 135 is not in contact with a tooth 130, a focal point 131 of the reflection/refraction is outside of the bristle 135. Then most of the radiation reflected by the beam reflector/refractor 132 may not reach the tooth 130 with sufficient intensity for dental cleaning or whitening, as shown in FIG. 8A. For example, some reflected radiation beams may not even enter into the bristle 135. The intensity of the radiation beams that do enter into the bristle 135 may be significantly weakened by reflection/refraction against the walls of the bristle 135. However, when the bristle 108 is pressed against the tooth 130 under sufficient pressure, a focal point 133 of the reflection/refraction is inside the bristle 135. Most of the radiation (e.g., laser energy) reflected by the beam reflector/refractor 132 may travel through the bristle 108 and fall on the tooth 130 with sufficient intensity for dental cleaning or whitening, as shown in FIG. 8B.

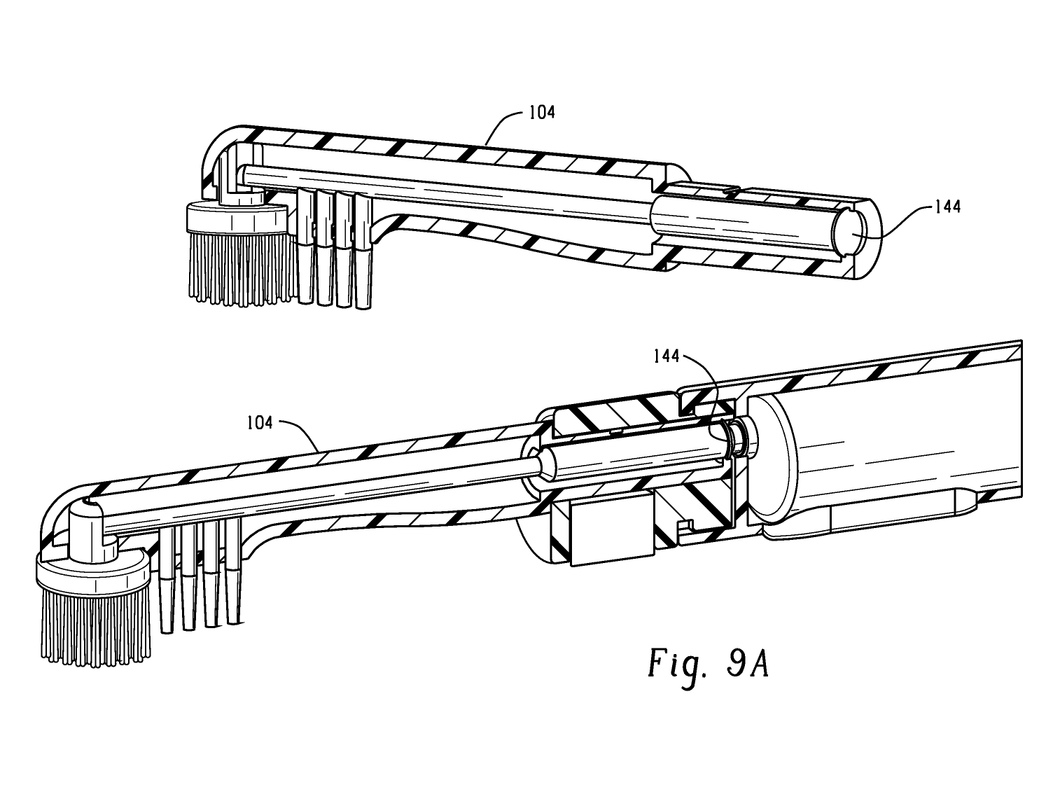

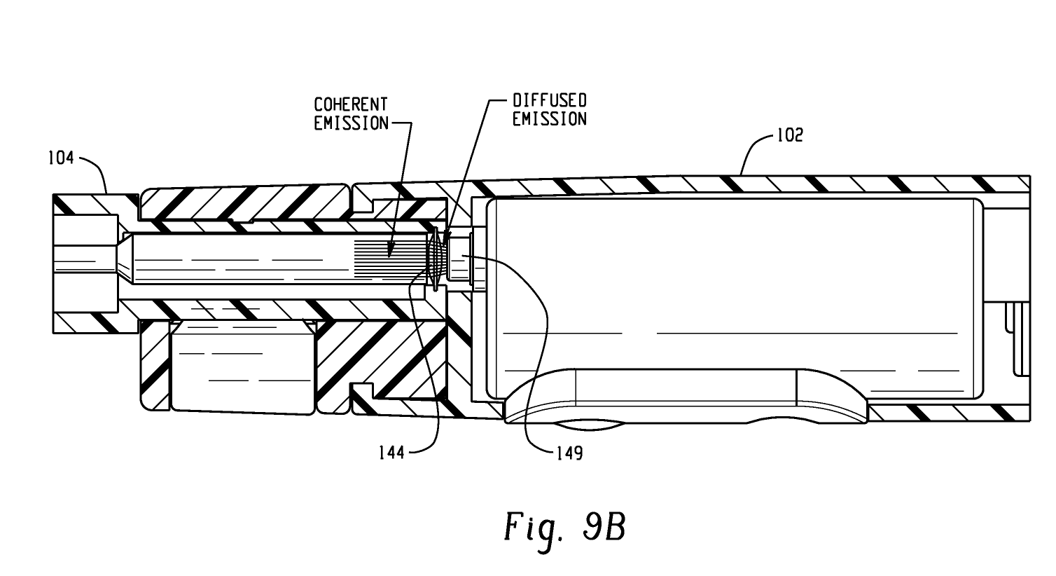

FIGS. 9A and 9B depict an example optical toothbrush with an optical coupling mechanism. As shown in FIGS. 9A and 9B, the brush head 104 includes a focus lens 144 to provide optical focus of the electromagnetic radiation generated from the radiation generation source contained in the brush body 102. When the brush head 104 and the brush body 102 are separated, the radiation generated by the radiation generation source contained in the brush body 102 is diffused. For example, the radiation generation source may include a laser diode and a diffuser. The laser diode can be used to generate laser radiation which can be diffused by the diffuser, and the diffused radiation may not cause physical harm to users. On the other hand, when the brush head 104 is attached to the brush body 102, the focus lens 144 contained in the brush head 104 may be aligned well with the outlet 149 of the radiation from the radiation generation source. The diffused radiation may be changed by the focus lens 144 into coherent emission (e.g., laser energy) which can then be transferred through the light pipe 106 to the bristles 108 for dental cleaning or whitening.

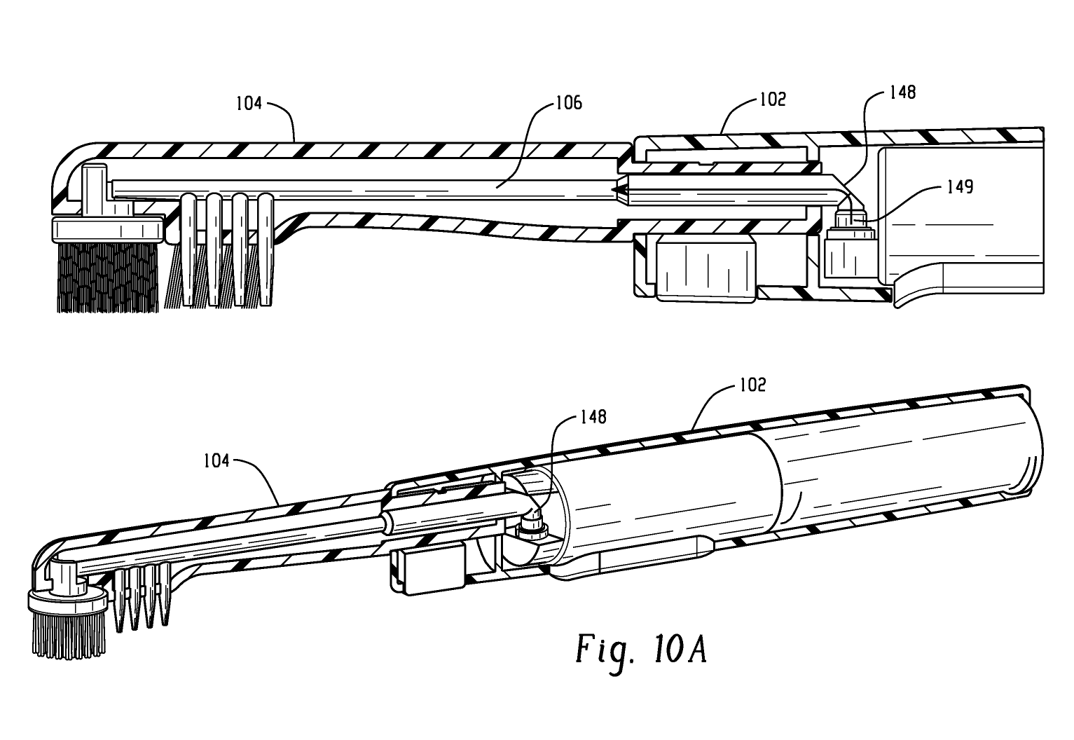

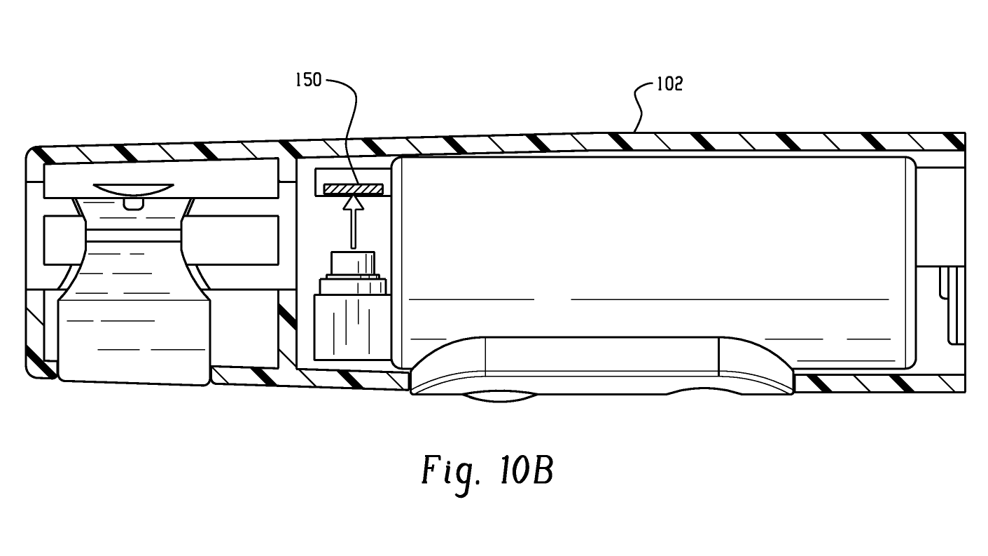

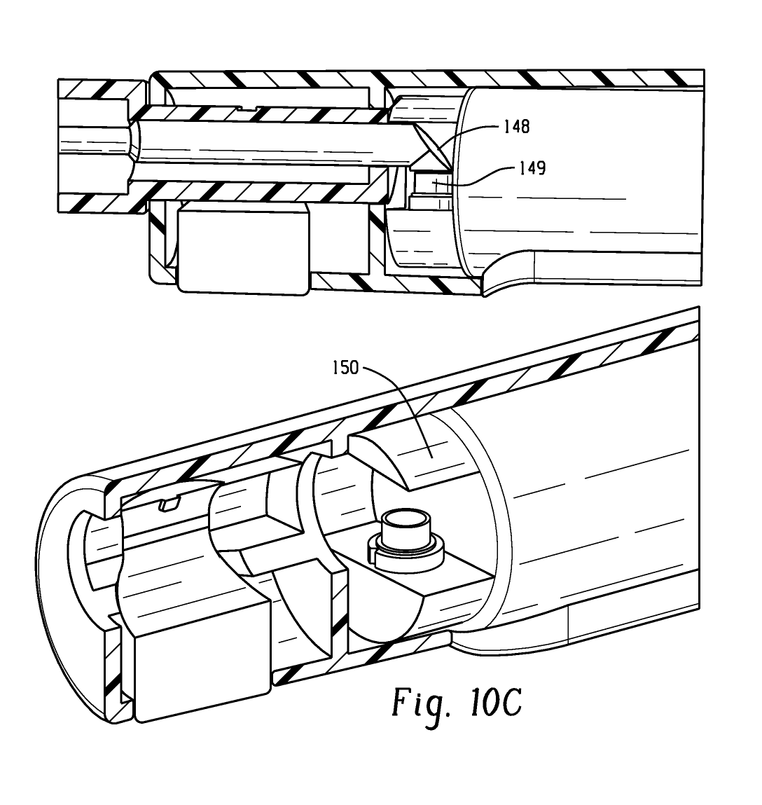

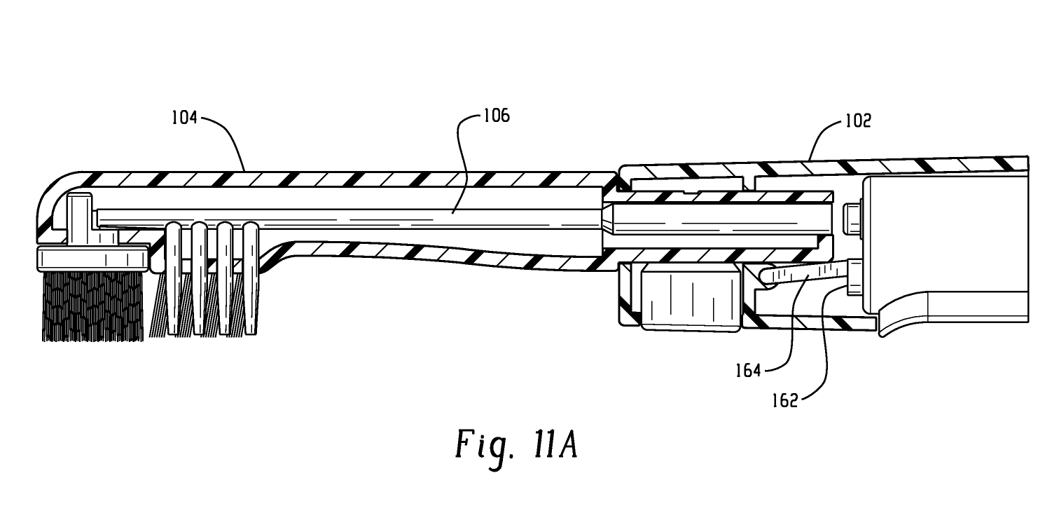

FIGS. 10A-10C depict an example optical toothbrush with another optical coupling mechanism. As shown in FIGS. 10A-10C, the light pipe 106 includes a faceted end 148 which can redirect the electromagnetic radiation (e.g., laser energy) generated from the radiation generation source contained in the brush body 102 and a beam barrier 150 which can block and diffuse the radiation. Specifically, as shown in FIG. 10B, when the brush head 104 and the brush body 102 are separated, the beam barrier 150 blocks and diffuses the radiation generated from the radiation generation source contained in the brush body 102 so that no coherent emission (e.g., laser energy) can go out of the brush body 102. When the brush head 104 is attached to the brush body 102, the bottom surface of the faceted end 148 may be aligned with the outlet 149. The radiation (e.g., laser energy) generated by the radiation generation source may be redirected (e.g., by 90 degrees) by the faceted end 148 and transferred through the light pipe 106 to the bristles 108 as shown in FIG. 10A. For example, a key feature may be included in the brush head 104 and a key slot may be included in the brush body 102 so that the brush head 104 can be inserted into the brush body 102 securely.

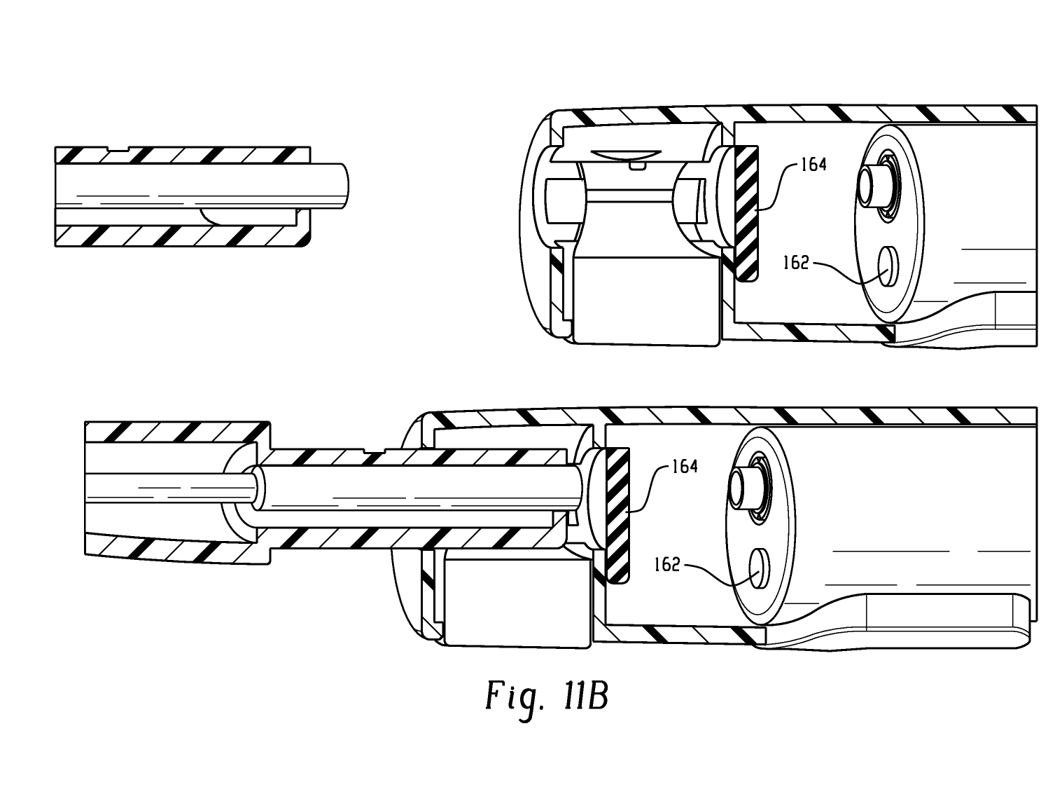

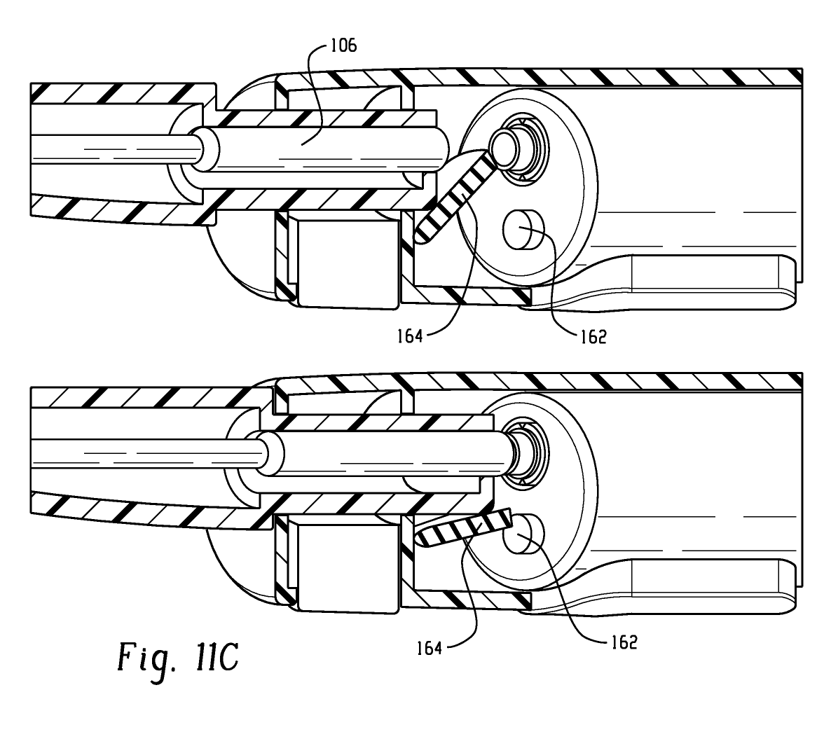

In addition, the optical toothbrush 100 may include mechanisms, as shown in FIGS. 11A-11C, to prevent the radiation generation source from being accidentally activated and prevent coherent electromagnetic radiation (e.g., laser energy) from emitting out of the toothbrush 100 unless certain events occur.

FIGS. 11A-11C depict an example optical toothbrush with a flap valve and a safety switch. As shown in FIGS. 11A-11C, the brush body 102 includes a safety switch 162 to prevent accidental activation of the radiation generation source contained in the brush body 102. In addition, the brush body 102 includes a flap valve 164 to prevent coherent radiation (e.g., laser energy) from emitting out of the brush body 102. Specifically, the radiation generation source may not be activated unless the safety switch 162 is engaged. Even if the radiation generation source is activated, no coherent radiation (e.g., laser energy) may emit out of the brush body 102 unless the flap valve is opened. As shown in FIG. 11B, when the brush head 104 and the brush body 102 are separated, the safety switch 162 is not engaged, and thus the radiation generation source is not activated. The flap valve 164 is closed at this time, and serves as an additional protection to block/diffuse any coherent radiation (e.g., laser energy) that may be generated by the radiation generation source. As shown in FIG. 11C, when the brush head 104 is inserted into the brush body 102, the brush head 104 pushes open the flap valve 164 so that the radiation can emit out of the brush body 102. However, if the safety switch 162 is not engaged, the radiation generation source may not be activated. In one embodiment, when the flap valve 164 is opened, it engages the safety switch 162 to activate the radiation generation source, as shown in FIG. 11C. In another embodiment, the safety switch 162 may automatically be engaged in response to the flap valve 164 being opened, even if the flap valve 164 does not physically touch the safety switch 162. For example, a sensor may be used to detect the opening of the flap valve 164 and then cause the safety switch 162 being engaged.

This written description uses examples to disclose the invention, include the best mode, and also to enable a person skilled in the art to make and use the invention. The patentable scope of the invention may include other examples that occur to those skilled in the art.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise.

1. A toothbrush including a body and a head, the toothbrush comprising:
an electromagnetic-radiation generation component configured to generate electromagnetic radiation upon activation, the electromagnetic-radiation generation component being located in a body of the toothbrush;
a safety component configured to activate the electromagnetic-radiation generation component in response to an activation event; and
a transmission component configured to transmit the electromagnetic radiation to the head of the toothbrush for dental cleaning or whitening.

2. The toothbrush of claim 1, wherein the activation event includes the head of the toothbrush being attached to the body of the toothbrush.

3. The toothbrush of claim 2, wherein the safety component is configured to be engaged to activate the electromagnetic-radiation generation component in response to the head of the toothbrush being attached to the body of the toothbrush.

4. The toothbrush of claim 2, wherein:
the safety component includes a valve and a safety switch;
the valve is configured to block the electromagnetic radiation when the head of the toothbrush is not attached to the body of the toothbrush and engage the safety switch in response to the head of the toothbrush being attached to the body of the toothbrush; and
the safety switch is configured to activate the electromagnetic-radiation generation component when the safety switch is engaged.

5. The toothbrush of claim 1, wherein:
the head including one or more bristles; and
the activation event includes a bristle being in contact with a tooth.

6. The toothbrush of claim 5, wherein the safety component includes one or more electrical components configured to output a signal, in response to the bristle being in contact with a tooth, to activate the electromagnetic-radiation generation component.

7. The toothbrush of claim 1, and further comprising a sensor configured to detect a reflection signal in response to a sensing signal being transmitted out of the toothbrush, the sensing signal being generated by the electromagnetic-radiation generation component;
wherein the activation event includes the reflection signal exceeding a predetermined power level.

8. The toothbrush of claim 7, wherein the head including one or more bristles, the reflection signal being detected through the one or more bristles.

9. The toothbrush of claim 8, wherein a bristle includes a tapered tip configured to bend in response to the bristle being in contact with a tooth.

10. The toothbrush of claim 1, wherein the activation event includes the safety component being engaged under a predetermined pattern.

11. The toothbrush of claim 10, wherein the activation event includes the safety component being engaged a predetermined number of times.

12. A toothbrush including a body and a head, the toothbrush comprising:
an electromagnetic-radiation generation component configured to generate electromagnetic radiation, the electromagnetic-radiation generation component being located in a body of the toothbrush;
a safety component configured to prevent the electromagnetic radiation from emitting out of the toothbrush until an actuation event occurs; and
a transmission component configured to transmit the electromagnetic radiation to a head of the toothbrush for dental cleaning or whitening.

13. The toothbrush of claim 12, wherein:
the head including one or more bristles; and
the actuation event includes a bristle being in contact with a tooth.

14. The toothbrush of claim 13, wherein the safety component includes an optical component configured to transmit the electromagnetic radiation out of a bristle when the bristle being in contact with a tooth.

15. The toothbrush of claim 14, wherein the optical component includes a beam reflector.

16. The toothbrush of claim 12, wherein the actuation event includes the head of the toothbrush being attached to the body of the toothbrush.

17. The toothbrush of claim 16, wherein the safety component includes a focus lens configured to receive a diffused electromagnetic radiation from the electromagnetic-radiation generation component and change the diffused electromagnetic radiation into a coherent electromagnetic radiation in response to the head of the toothbrush being attached to the body of the toothbrush.

18. The toothbrush of claim 16, wherein the safety component includes a barrier configured to block the electromagnetic radiation when the head of the toothbrush is not attached to the body of the toothbrush.

19. The toothbrush of claim 18, wherein the safety component further includes an optical component configured, in response to the head of the toothbrush being attached to the body of the toothbrush, to receive the electromagnetic radiation at a first direction and output the electromagnetic radiation at a second direction.

20. The toothbrush of claim 18, wherein:
the safety component further includes a safety switch;
the barrier is configured to engage the safety switch in response to the head of the toothbrush being attached to the body of the toothbrush; and
the safety switch is configured to activate the electromagnetic-radiation generation component when the safety switch is engaged by the barrier.
